(19) United States
(12) Patent Application Publication
(10) Pub. No.: US 2023/0120151 A1
(43) Pub. Date: Apr. 20, 2023

(54) IMPROVED CURRENT COLLECTOR FOR A BATTERY

(71) Applicant: SAFT, LEVALLOIS PERRET (FR)

(72) Inventors: Vincent PELE, BORDEAUX (FR); Christian JORDY, ST LOUIS DE MONTFERRAND (FR); Nadège ROUMEGOUS, AMBARES ET LAGRAVE (FR)

(73) Assignee: SAFT, LEVALLOIS PERRET (FR)

(21) Appl. No.: 17/914,426

(22) PCT Filed: Mar. 24, 2021
(86) PCT No.: PCT/EP2021/057578

§ 371 Date: Sep. 26, 2022

(30) Foreign Application Priority Data
Mar. 26, 2020 (FR) FR2002977

(51) Int. Cl. H01M 4/62; H01M 4/66; H01M 4/04; H01M 10/0562

(52) U.S. Cl. CPC H01M 4/628; H01M 4/661; H01M 4/0404; H01M 10/0562; H01M 2004/027

(57) ABSTRACT

The present invention relates to a current collector for a negative electrode, coated with at least one electronically conducting and ionically insulating layer, to the method for producing such a collector, and to batteries containing same.

### CROSS REFERENCE TO RELATED APPLICATIONS

The present application is a U.S. National Phase Application under 35 U.S.C. § 371 of International Patent Application No. PCT/EP2021/057578 filed Mar. 24, 2021, which claims priority of French Patent Application No. 20 02977 filed Mar. 26, 2020. The entire contents of which are hereby incorporated by reference.

### FIELD OF THE INVENTION

The present invention relates to the field of energy storage, and more precisely accumulators, in particular lithium accumulators.

### BACKGROUND

Rechargeable lithium-ion batteries offer excellent energy and volume densities and today occupy a prominent place on the market for portable electronics, electric and hybrid vehicles, or stationary energy storage systems.

Their operation is based on the reversible exchange of lithium ions between a positive electrode and a negative electrode, separated by an electrolyte.

Solid electrolytes also offer a significant improvement in terms of safety as they present a much lower risk of flammability than liquid electrolytes.

However, the properties of solid electrolytes suffer from degradation in contact with moisture. In the case of sulfide electrolytes, moisture leads in particular to the emission of harmful gases (H₂S) which is likely to corrode the materials generally used for current collectors and copper in particular, which is generally used for negative electrode current collectors.

It is therefore desirable to protect the current collectors from sulfide electrolytes.

EP1032064 aims to protect the current collector of a positive aluminum electrode against corrosion, by means of very alkaline positive electrode metals: it is therefore a question of locally reducing the pH. In addition, these positive electrodes are used with a liquid electrolyte.

US2012/0237824 also aims to protect the current collector of the negative electrode.

WO2019/045399 relates to liquid electrolyte battery technology.

Therefore, the proposed protections mainly relate to the protection of positive current collectors and/or liquid electrolytes.

It is therefore necessary to protect current collectors to avoid direct contact with a solid sulfide electrolyte, while maintaining the electronic conduction between the electrolyte and the collector.

### SUMMARY

The invention proposes to solve this problem by providing a layer for protecting the current collector, which is electronically conducting and insulates from Li⁺ ions.

Thus, according to a first object, the present invention relates to a negative electrode current collector comprising a material that may be corroded as a result of the use of sulfides in the cell, characterized in that the collector is coated with at least one protective layer, which is electronically conducting and insulates from Li⁺ ions.

According to one embodiment, the negative electrode contains particles of active material and particles of sulfide electrolyte. There is therefore, in this case, direct contact between the current collector and the sulfide electrolyte. In this case, the current collector is intended to be protected from said particles.

According to this embodiment, said protective layer is located at the interface between the current collector and the particles of active material and electrolyte constituting the composite anode.

According to one embodiment, the negative electrode contains an active mass comprising the active material. Particles of sulfide electrolyte are not necessarily present in the negative electrode. Even if there is no direct contact between the current collector and the sulfide electrolyte, the sulfide electrolyte produces H₂S in the presence of even a very low humidity level. It is also necessary, in this case, to protect the current collector from H₂S, which is a very corrosive gas.

According to this embodiment, said protective layer is located at the interface between the current collector and the active mass of the electrode.

The corrosion described here can occur as a result of direct contact between sulfide particles and the current collector, but also via the generation of H₂S gas (formed in particular in the presence of moisture), the presence of which is likely to corrode materials used in the composition of usual current collectors.

The term “electrical conductor” used here refers to the ability of the protective layer to allow the flow of the electric current.

The term “insulates from Li⁺ ions” used here refers to the ability of said layer to inhibit the transit of Li+ ions through said layer, between the active mass of the negative electrode and the current collector. The active mass comprises the active material, an optional binder, an optional solid electrolyte, and an optional electronic conductor.

According to one embodiment, said layer consists of a material that is not reactive with sulfides and does not lithiate.

According to one embodiment, said at least one layer contains at least one material selected from carbon, silicon, and mixtures thereof.

According to this embodiment, the thickness of said at least one layer is between 1 and 100 nm, preferably 3 to 10 nm.

According to another embodiment, said layer contains at least one material selected from chromium, chromium oxide, or nickel oxide, and mixtures thereof, or stainless steel.

According to this embodiment, the thickness of said at least one layer is between 1 and 100 nm, it being understood that in the case of oxides, the thickness is preferably between 1 and 10 nm.

According to one embodiment, said layer is devoid of fluorinated resin and/or oxalate.

Said collector usually comes in the form of a strip of conducting material, such as a metal. Examples of materials that are likely to be corroded include in particular materials such as nickel, copper, iron, molybdenum, zinc, and manganese. According to one embodiment, the material likely to be corroded is copper.

According to one embodiment, said current protector may be coated with one or more layers such as the aforementioned, identical, or different.

According to one embodiment, the current collector according to the invention is suitable for solid sulfide electrolytes. Examples of sulfide electrolytes may include Li₃PS₄ and all phases [(Li₂S)_{y}(P₂S₅)_{1-y}]_{(1-z)}(LiX)_{z} (with X being a halogen element; 0<y<1; 0<z<1), argyrodites such as Li₆PS₅X, with X═Cl, Br, I, or Li₇P₃S₁₁, the sulfide electrolytes having the crystallographic structure equivalent to the compound Li₁₀GeP₂S_{12.}

According to one embodiment, the current protector according to the invention further comprises sulfur, in the form of a sulfide or a sulfur-based compound.

According to another object, the present invention also relates to a method of preparing a coated current collector according to the invention, said method comprising the deposition said layer on the collector.

According to one embodiment, the deposition is carried out by physical or chemical vapor deposition (PVD or CVD).

The PVD technique refers to any method of vacuum deposition of thin films, and includes in particular deposition:
by direct evaporation (vacuum evaporation or evaporation; electron beam evaporation);
by cathode pulverization (“sputtering”) by ion bombardment;
pulsed laser deposition or pulsed laser ablation under the action of intense laser radiation;
by molecular jet epitaxy; and
by electric arc deposition (Arc-PVD) by vaporization under the action of a strong current, caused by electrical discharge between two electrodes with a large potential difference.

In particular, the protective layer can be deposited by PVD by cathodic pulverization (PECVD).

CVD involves exposing the substrate to one or more gaseous-phase precursors, which react and/or decompose on the surface of the substrate to create the desired deposition. Materials in various forms can be deposited: monocrystalline, polycrystalline, amorphous, and epitaxial. These materials include silicon, silica, silicon-germanium, silicon carbides, diamond carbon, fibers, nanofibers, filaments, carbon nanotubes, tungsten, materials with high electrical permittivity, etc.

CVD techniques vary depending on the means by which chemical reactions are initiated and by the process conditions:
Classification according to total pressure
   Atmospheric pressure CVD (APCVD)—CVD performed at atmospheric pressure.
   Low-pressure CVD (LPCVD)—CVD performed at sub-atmospheric pressure¹. Reduced pressures tend to reduce unwanted gaseous phase reactions and increase the uniformity of the films along the substrates. Most current CVD processes are either LPCVD or UHVCVD.
   Ultra-high vacuum CVD (UHVCVD)—CVD performed at very low pressure, typically under 10⁻⁶ Pa (˜10⁻⁸ torr). NB: in other fields, a subdivision between “high” and “ultra-high vacuum” is common, often lying at 10⁻⁷ Pa.
Classification according to the physical characteristics of the reagent
   Aerosol assisted CVD (AACVD)—in which the precursor is transported to the substrate by means of a liquid aerosol: gas that can be generated by ultrasound. This technique is appropriate for the use of non-volatile precursors.
   Direct liquid injection CVD (DLICVD)—in which the precursors are in the liquid state (liquid or solid dissolved in a suitable solvent). Liquid solutions are injected into a vaporization chamber by means of injectors. The precursors are then transported to the substrate, as in a conventional CVD process. This technique is suitable for the use of liquid or solid precursors. High growth rates can be achieved by this technique.
Plasma-assisted processes
   Microwave plasma-assisted CVD (MPCVD)
   Plasma-enhanced CVD (PECVD)—in which a plasma is used to increase the rate of reactions of precursors². This variant allows deposition at lower temperatures (temperature is often a blocking point).
   Remote plasma-enhanced CVD (RPECVD)—Similar to PECVD, except that the substrate is not directly in the plasma discharge region. This allows for treatments at room temperature.
Atomic layer CVD (ALCVD)—Deposition of successive layers of different substances (see epitaxy)
Hot wire CVD (HWCVD)—Also known as catalytic CVD (Cat-CVD) or hot-filament CVD (HFCVD). Uses a hot filament to chemically decompose source gases³.
Metalorganic chemical vapor deposition (MOCVD)—CVD processes using metalorganic precursors.
Hybrid physical-chemical vapor deposition (HPCVD)—vapor deposition process that involves both the chemical decomposition of a gaseous precursor and the vaporization of a solid.
Rapid thermal CVD (RTCVD)—CVD uses heat lamps or other methods to quickly heat the substrate. Heating only the substrate rather than the gas or chamber walls helps reduce unwanted reactions that can lead to the formation of unexpected particles.
Vapor Phase Epitaxy (VPE).

Specifically, the protective layer can be deposited by CVD by atomic layer deposition (ALD) or by RECVD.

According to another object, the present invention also relates to an electrode comprising a coated current collector according to the invention, such that said active material of said electrode is graphite.

According to one embodiment, said electrode is a negative electrode.

According to another object, the present invention also relates to an electrochemical element comprising a coated current collector according to the invention and a solid sulfide electrolyte.

“Electrochemical element” means an elementary electrochemical cell consisting of the positive electrode/electrolyte/negative electrode assembly, which makes it possible to store the electrical energy provided by a chemical reaction and to return it in the form of a current.

The electrochemical elements according to the invention are preferably accumulators of which the capacity is greater than 100 mAh, typically 1 to 100 Ah.

According to another object, the present invention also relates to an electrochemical module comprising the stacking of at least two elements according to the invention, each element being electrically connected to one or more other element(s).

The term “module” therefore refers here to the assembly of a plurality of electrochemical elements, it being possible for said assemblies to be in series and/or parallel.

According to another of these objects, the invention also relates to a battery comprising one or more modules according to the invention.

“Battery” means the assembly of a plurality of modules according to the invention.

According to one embodiment, the battery may be a Li-ion battery or a solid-state battery.

### BRIEF DESCRIPTION OF THE DRAWINGS

FIGS. 1a and 1b show the structure of an electrochemical element according to the invention (FIG. 1a) and the detail of the current collector (FIG. 1b).

FIG. 2 shows the values of discharged capacity and coulombic efficiency obtained for a cell according to the invention (Cu—Si) and a comparative cell (Cu).

### DETAILED DESCRIPTION

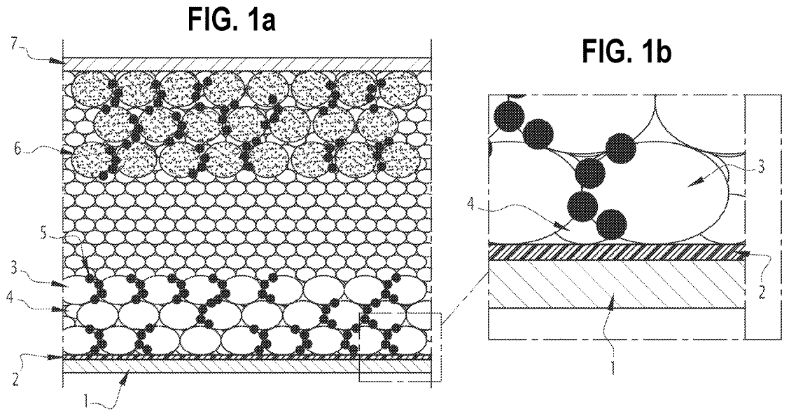

FIG. 1a schematically shows an electrochemical element comprising, at the negative electrode: a current collector (1) coated with a protective layer (2) according to the invention, and at the positive electrode, a current collector (7). The chemical element shown is solid-state, where the anode and cathode are composite, being made of a mixture of active material (3) and (6), respectively, and electrolyte (4).

The anode and the cathode are separated by the electrolyte.

As shown in FIG. 1b the protective layer (2) acts as an interface between the collector (1) and the particles of active material (3) and electrolyte (4) constituting the composite anode. In addition, conducting particles (5), such as carbon black, are inserted into the mixture comprising the active material (3) and the electrolyte (4). The active material is typically graphite. The electrolyte can in particular be a solid sulfide electrolyte.

According to an alternative configuration (not shown), the chemical element can also be of all-solid Li-metal, where the negative electrode can contain an alkali metal in the charged state, such as lithium metal.

[symbol]

Coulombic efficiency is the ratio of the capacity recovered in discharge divided by the capacity provided during the previous charge.

The following examples are given for illustrative and non-limiting purposes of the invention:

### EXAMPLE

All the manipulations of the powders were carried out in a glove box under an argon atmosphere. The solid electrolyte used in this example is an argyrodite Li₆PS₅Cl (˜1 mS/cm at room temperature). The composite mixture of NCA and sulfide electrolyte (SE) used as a positive electrode was prepared manually with a mortar according to the NCA:SE mass quantities of 70:30. The mixture used as a negative electrode is prepared, according to the same protocol, from graphite and SE in graphite:SE mass proportions of 2:1. The complete graphite/SE/NCA cells were prepared in specific cells, similar to 7 mm diameter pellet molds of which the pistons are made of stainless steel and the body is made of electrically insulating material. First, 40 mg of electrolyte is introduced and then compressed under 250 MPa to form the separating electrolyte layer (SEL). The cell is then opened on one side to introduce 15 mg of the positive electrode mixture and an aluminum disc (acting as a current collector). The positive electrode is formed by compression at 250 MPa. 12 mg of the negative electrode mixture and a copper current collector are then introduced on the other side of the SEL. The entire cell is then compressed under 500 MPa for several minutes. A pressure of 250 MPa is maintained on the cell thereafter using screws. This first cell is referred to as “Comparative Example: Cu” in the graphical representations.

A second cell is assembled under the same conditions, but the copper collector of the negative electrode is replaced by a collector from the same copper strip, but on which a layer of 50 nm of silicon has previously been deposited by PECVD. This second cell is referred to as “Example 1: Cu—Si” in the graphical representations.

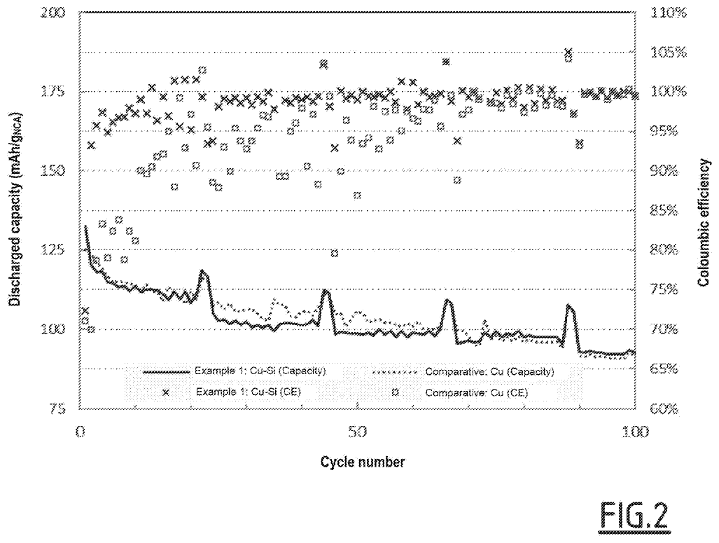

After a rest of 12 hours, the cells thus assembled are then characterized by galvanostatic cycling between 2.8 and 4.1 V at room temperature. The sequence [1 control cycle at C/20—20 cycles at C/10—1 control cycle at C/20] is repeated 7 times. FIG. 2 shows the discharged capacity and coulombic efficiency values obtained for these cells. Both cells have similar discharged capacity values during the first 100 cycles while the coulombic efficiency obtained for the cell containing the copper collector with silicon deposition is significantly improved compared to the comparative example. Indeed, the averages of the coulombic efficiency values between the 2nd and 22nd cycles (first sequence, excluding first cycle) are 97.6% for Example 1: Cu—Si and only 87.6% for the comparative example, respectively.

This discrepancy demonstrates the important reactions occurring within the negative electrode, especially between the sulfide electrolyte and the copper current collector. A protective layer of only 50 nm can significantly reduce these instabilities.

1. A negative electrode current collector comprising a material likely to be corroded in the presence of sulfides, wherein the collector is coated with at least one protective layer which is electronically conducting and insulates from Li⁺ ions, such that the protective layer is located at the interface of the collector with the active mass of the electrode.

2. The negative current collector according to claim 1, wherein said at least one protective layer contains at least one material selected from carbon, silicon, and mixtures thereof.

3. The negative current collector according to claim 1, wherein said protective layer contains at least one material selected from chromium, chromium oxide, or nickel oxide, or stainless steel.

4. The negative current collector according to claim 1, wherein said protective layer is devoid of at least one of fluorinated resin and oxalate.

5. The negative current collector according to claim 1, wherein the material that is likely to be corroded is copper.

6. A method of preparing a coated current collector according to claim 1, wherein said method comprises the deposition of said protective layer on the collector.

7. The method according to claim 5, wherein the deposition is carried out by physical or chemical vapor deposition (PVD or CVD).

8. The electrode comprising a coated current collector according to claim 1, wherein said active material of said electrode is graphite.

9. The electrochemical element comprising a coated current collector according to claim 1 and a solid sulfide electrolyte.

10. The electrochemical module comprising the stacking of at least two elements according to claim 8, each element being electrically connected to one or more other element(s).

11. The battery comprising one or more modules according to claim 9.
